(19) United States
(12) Patent Application Publication
(10) Pub. No.: US 2014/0189995 A1
(43) Pub. Date: Jul. 10, 2014

(54) METHODS FOR INSTALLING REACTOR COOLANT LOOP PIPING IN A NUCLEAR POWER PLANT

(71) Applicants: Xuancui Liang, Shanghai (CN); Weihua Liu, Shanghai (CN); Jian Li, Shanghai (CN); Peike Dong, Shanghai (CN); Dunquan Tan, Shanghai (CN); Yongqing Li, Shanghai (CN); Haibing Ju, Shanghai (CN); Rongmin Wang, Shanghai (CN); Hongbing Wei, Shanghai (CN); Bin Xu, Shanghai (CN); Rui Gou, Shanghai (CN); Yunyang Li, Ivzhou Mingyuan (CN); Wei Li, Shanghai (CN); Qiang Guo, Shanghai (CN); Mingbao Qin, Shanghai (CN); Xiao Wang, Shanghai (CN)

(72) Inventors: Xuancui Liang, Shanghai (CN); Weihua Liu, Shanghai (CN); Jian Li, Shanghai (CN); Peike Dong, Shanghai (CN); Dunquan Tan, Shanghai (CN); Yongqing Li, Shanghai (CN); Haibing Ju, Shanghai (CN); Rongmin Wang, Shanghai (CN); Hongbing Wei, Shanghai (CN); Bin Xu, Shanghai (CN); Rui Gou, Shanghai (CN); Yunyang Li, Ivzhou Mingyuan (CN); Wei Li, Shanghai (CN); Qiang Guo, Shanghai (CN); Mingbao Qin, Shanghai (CN); Xiao Wang, Shanghai (CN)

(21) Appl. No.: 13/980,800

(22) PCT Filed: Nov. 4, 2011
(86) PCT No.: PCT/CN2011/081795

§ 371 Date: Oct. 31, 2013

(30) Foreign Application Priority Data
Jan. 19, 2011 (CN) 201110021749.0

(51) Int. Cl. G21C 21/00

(52) U.S. Cl. CPC G21C 21/00
USPC 29/428

(57) ABSTRACT

Method for installing reactor coolant loop (RCL) piping of a reactor coolant system (RCS) system in a pressurized water reactor (PWR) nuclear power plant by positioning the reactor vessel, steam generator, or both, into position after attaching one or more coolant pumps, surveying coolant loop piping and a plurality of nozzles on the reactor vessel, the steam generator and coolant pump casing, or a combination thereof, with a precise measurement and 3D modeling technology for positioning data, then performing weld prep machining for the coolant loop piping on the reactor vessel side, and machining for the coolant loop piping on the steam generator side and coolant pump side based on the positioning data, and installing temporary supports for coolant loop piping and finishing the fit-up and welding between the coolant loop piping and the reactor vessel, steam generator, and each coolant pump.

### CROSS-REFERENCE TO RELATED APPLICATIONS

This is the national stage of PCT/CN2011/081795, filed Nov. 4, 2011, which claims the benefit of CN20110021749, filed Jan. 19, 2011, the contents of each of which is hereby incorporated herein in its entirety by express reference thereto.

### TECHNICAL FIELD

The invention relates to the installation method for reactor coolant loop (RCL) piping of the reactor coolant system (RCS) in pressurized water reactor (PWR) nuclear power plants.

### BACKGROUND ART

The pipes for reactor coolant systems system of nuclear power plants (also hereinafter referred to as RCL Piping) are the closed loop to connect the reactor pressure vessel, steam generator, and the reactor coolant pump (also hereinafter referred to as RCP or coolant pump) (the above four items are collectively called nuclear island primary system equipments), so the pipe is the most important nuclear safety class 1 equipment in pressurized water reactor nuclear power plants. Medium in the pipe is radioactive boron water. The reactor coolant loop piping of each loop comprises one hot leg connecting a reactor pressure vessel and a steam generator and two cold legs connecting a reactor pressure vessel and coolant pumps. The reactor coolant system of the nuclear power plant in the invention takes two or three loops as examples. The coolant of the nuclear reactor is driven by coolant pump and transferred to the reactor pressure vessel through cold legs. After being heated by the heat generated from the reaction in the reactor pressure vessel, the coolant is transferred to the steam generator through hot legs. Then, the coolant is driven by coolant pump and returned to the reactor pressure vessel through cold legs. One cycle is completed.

Due to the radioactivity of the nuclear reactor, the loops formed among the reactor pressure vessel, the steam generator and coolant pumps are connected by the reactor coolant loop piping in the form of fit-up and welding. Two ends of each section of the reactor coolant loop piping have at least two weld seams and each loop has at least six weld seams. The reactor coolant loop piping of the nuclear power plant has great diameter and thickness, so the quality of welding is required strictly. The reactor coolant loop piping is all connected with nuclear safety class 1 equipment. The equipment has complex structures, so the construction will cost long period and undertake significant risk. As for the existing technologies, transition sections are often used to adjust the deviation during installation when the reactor coolant loop piping is installed into the reactor coolant system of pressurized water reactor nuclear power plants. For example, the reactor coolant loop piping described in the prospectus CN101839467A is installed in that way. The differences between the length of the reactor coolant loop piping and the machining of weld prep shape of the invention and those described in the prospectus CN101839467A lie in the differences in the shape, arrangement and installing sequence of the reactor coolant loop piping; higher requirements for installation, namely the weld prep fit-up tolerance is less than or equal to 0.8 mm and fit-up gap is less than or equal to 1.0 mm. Before the primary system equipments leave the factory, nozzles (also known as safety end) fitting the reactor coolant loop piping are all processed in the place of the supplier, including the orientation of nozzles and weld prep profile, while all the weld preps at two ends of the reactor coolant loop piping must be processed on the construction site based on the dimensions of nozzles at the safety ends of the reactor pressure vessel, the steam generator and coolant pump and the errors in manufacturing systems, manufacture errors of the reactor coolant loop piping and the radius curvature of bents. The invention adopts modeling selecting control points on the actual equipments and data fitting to enter the data into movable NC weld prep machine. The reactor coolant loop piping is machined through numerical control and the machining amount is reserved to enable the reactor coolant loop piping to match the weld preps of the primary system equipments and to satisfy that three fixed nozzles are fit up simultaneously and successfully with the best matching methods. Three nozzles can be fit up simultaneously in three dimensions with laser tracking metrology technology and 3D modeling technology.

### DISCLOSURE

### Technical Problem

The invention aims at providing laser tracking metrology and 3D modeling technology and field NC-tracking weld prep machining technology to develop corresponding dedicated tools and improving work efficiency to shorten the construction period. The invention provides the methods for installing the reactor coolant loop piping, construction procedure and the new technology used for satisfying the installation requirements and also solves the problems in fit-up and welding, as a result, the installation and construction of the reactor coolant loop piping can get started regardless of the delivery sequence of primary system equipments;

The invention also aims at correcting the installation deviation of the reactor coolant loop piping, improving the installation accuracy and reducing the stress, so that even though no transition section is used to adjust the installation deviation, the invention can ensure that after the cold and hot legs of the reactor coolant loop piping are welded on the nozzles of the primary system equipment on one side, simultaneous welding with the nozzles of other primary system equipment can be conducted on the other side, or that six nozzles are fit up simultaneously and the fit-up gap and tolerance can meet the requirements.

The invention solves the problem about the installation methods for reactor coolant loop piping of new type reactor coolant system, including installation procedure and new technology to be used. In case of the arrival of the reactor coolant loop piping, different delivery sequence of primary system equipments allows the installation and construction of the reactor coolant loop piping through the optimization of working procedures.

### Technical Solution

The invention can be realized with an installation method for reactor coolant loop piping of the reactor coolant system in pressurized water reactor nuclear power plants, namely a steam generator is connected with each coolant pump directly and the steam generator (1), coolant pump (2) and a reactor pressure vessel (3) are connected with each other through the reactor coolant loop piping (4) by means of fit-up and welding. The reactor coolant loop piping consists of cold legs (41) and hot legs (42) and is characterized in that laser tracking metrology technology is used during the installation. Any of the loop reactor coolant loop piping in the reactor coolant system of pressurized water reactor nuclear power plants is installed according to the steps below:

Step 1: After all the prerequisites for installation have been satisfied, set the the reactor pressure vessel (3) and/or the the steam generator (1) and reactor coolant loop piping (2) into position;

Step 2: survey reactor coolant loop piping (4) and the nozzles on the reactor pressure vessel (3) and/or the nozzles on the steam generator (1) and coolant pump (2) casing by using laser measurement or other precise measurement technologies and 3D modeling technology; Perform the weld prep machining for reactor coolant loop piping (4) on the reactor pressure vessel (3) side, and/or the machining for reactor coolant loop piping on the steam generator (1) side and coolant pump (2) side. Survey the preps for specific data;

Step 3: install temporary supports for reactor coolant loop piping (4); and finish the welding between reactor coolant loop piping (4) and the reactor pressure vessel (3) and between the steam generator (1) and coolant pump (2);

The mentioned step 1 and step 2 can be swapped.

Step 3 includes the following specific processes:

Process 1: finish the welding of joints (341) (342) between reactor coolant loop piping (4) and the reactor pressure vessel (3);

Process 2: conduct 3D modeling for nozzles of reactor coolant loop piping (4), the steam generator and coolant pump by using laser measurement or precise measurement technologies and 3D modeling technology, survey the nozzles of reactor coolant loop piping (4) at the steam generator side, and perform the weld prep machining;

Process 3: set and adjust the steam generator (1), finish the fit-up and welding of the joint (142) between reactor coolant loop piping hot leg (42) and the steam generator (1) and the joint (241) between reactor coolant loop piping cold leg (41) and coolant pump (2) so as to complete the installation of reactor coolant loop piping.

Step 3 also includes the following specific processes:

Process 1: finish the welding of joints (142) (241) between reactor coolant loop piping (4) and the steam generator (1) and coolant pump (2);

Process 2: conduct modeling for nozzles of reactor coolant loop piping (4) and the reactor pressure vessel (3) by using laser measurement or precise measurement technologies and 3D modeling technology, survey the nozzle of reactor coolant loop piping (4) at the reactor pressure vessel side, and perform the weld prep machining;

Process 3: set and adjust the reactor pressure vessel (3), finish the fit-up and welding of joints (341) (342) between reactor coolant loop piping (4) and the reactor pressure vessel (3) so as to complete the installation of reactor coolant loop piping.

For step 3, if the reactor pressure vessel (3) and the steam generator (1) are in place, the reactor coolant loop piping (4) bent section shall be assembled and welded first followed by the straight section. The specific processes include:

Process 1: finish the welding of the joint (341) between reactor coolant loop piping (4) cold leg (412) bent and the reactor pressure vessel (3); finish the welding of the joint (142) between reactor coolant loop piping (4) hot leg bent and the steam generator (1);

Process 2: conduct modeling for joints of reactor coolant loop piping (4), the reactor pressure vessel (3) and coolant pump (2) by using laser measurement or precise measurement technologies and 3D modeling technology; finish machining and fit-up by installing reactor coolant loop piping (4) hot leg from the joint (142) at the steam generator (1) end to the reactor pressure vessel (3) end; finish machining and fit-up by installing reactor coolant loop piping cold leg from the joint (341) at the reactor pressure vessel (3) end to coolant pump end ;

Process 3: finish the welding of the joint (342) between reactor coolant loop piping hot leg (421) straight and the reactor pressure vessel (3) and the joint (241) between reactor coolant loop piping cold leg (411) straight and coolant pump (2) so as to complete the installation of reactor coolant loop piping.

For step 3, if the reactor pressure vessel (3) and the steam generator (1) are in place, the reactor coolant loop piping (4) straight section shall be assembled and welded first followed by the bent section. The specific processes include:

Process 1: finish the welding of the joint (241) between reactor coolant loop piping (4) cold leg (411) straight and coolant pump (2); finish the welding of the joint (342) between reactor coolant loop piping (4) hot leg (421) straight and the reactor pressure vessel (3);

Process 2: conduct modeling for the joint of reactor coolant loop piping (4), the reactor pressure vessel (3) and coolant pump (2) by using laser measurement or precise measurement technologies and 3D modeling technology; finish machining and fit-up by installing reactor coolant loop piping (4) hot leg from the joint (342) at the reactor pressure vessel (3) end to the steam generator (1) end; finish machining and fit-up by installing reactor coolant loop piping cold leg from the joint (241) at coolant pump end to the reactor pressure vessel (3) end;

Process 3: finish the welding of the joint (142) between reactor coolant loop piping hot leg (422) bent and the steam generator (1) and the joint (341) between reactor coolant loop piping cold leg (412) bent and the reactor pressure vessel (3) so as to complete the installation of reactor coolant loop piping.

For step 3, if the reactor pressure vessel (3) and the steam generator (1) are in place, the cold and hot legs (41, 42) of reactor coolant loop piping shall be welded at the same time. The specific processes include:

Process 1: conduct measurement and modeling for nozzles of the steam generator (1), coolant pump (2), the reactor pressure vessel (3) and reactor coolant loop piping (4) by using laser measurement or precise measurement technologies and 3D modeling technology, survey the cold legs (41) and the hot legs (42) of reactor coolant loop piping (4), and perform the weld prep machining;

Process 2: adjust the position of the steam generator (1) and reactor coolant loop piping (4), to conduct welding for six joints simultaneously or successively, thus finishing the installation.

For the measurement of reactor coolant loop piping (4), precise laser measurement technology and 3D modeling technology are preferred to conduct measurement and 3D modeling for nozzles of reactor coolant loop piping (4) and primary system equipment, and reactor coolant loop piping (4) shall be machined and installed according to the model calculation results.

Numerical control machining technology is preferred when machining reactor coolant loop piping (4).

The narrow groove automatic welding technology is preferred when welding reactor coolant loop piping (4).

### Advantageous Effects

The invention has the advantages that the transition section is removed so that the structure of the reactor coolant loop piping is simplified; elbows are reduced so that in the loop a steam generator can be connected with coolant pump directly; the number of weld seams is reduced so as to save materials, optimize the procedures and improve the working efficiency. In addition, during the installation of the nuclear island reactor coolant loop piping, the invention adopts laser measurement or accurate measurement technology and 3D modeling technology and performs 3D modeling and data fitting of the dimensions of pipe nozzles to the primary system equipment and the pipe nozzles on its safety end; the invention determines the length and weld prep profile of reactor coolant loop piping which shall be achieved after being machined on site and overcomes the errors and welding stress caused by adjustment and installation deviation without transition section.

### DESCRIPTION OF DRAWINGS

FIG. 1: Sketch of reactor coolant system of pressurized water reactor nuclear power plants composed of two loops.

FIG. 2: Top view of reactor coolant system of pressurized water reactor nuclear power plants and layout of joint number.

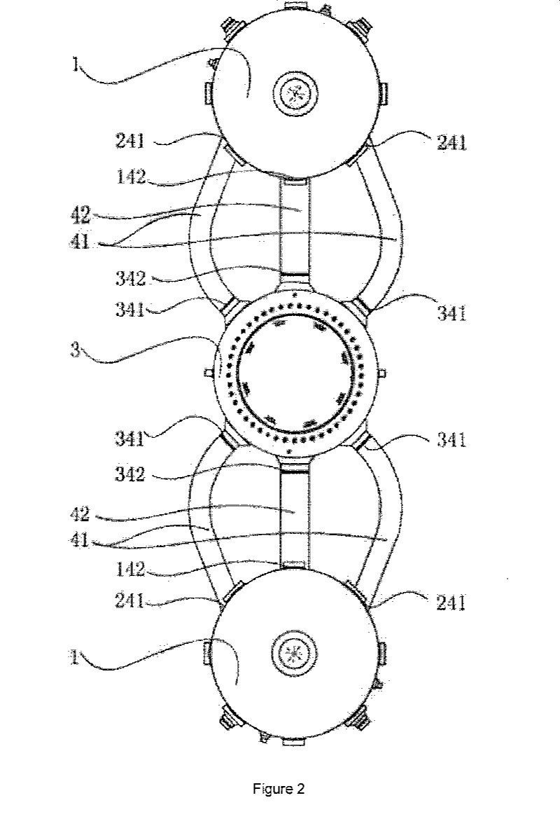

FIG. 3: Sketch of straight and bent sections of reactor coolant loop piping with two loops as examples.

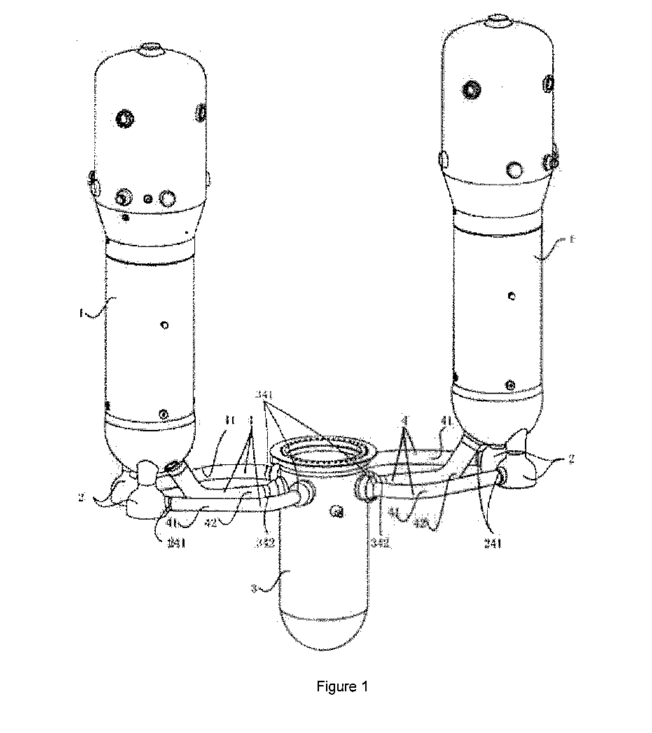

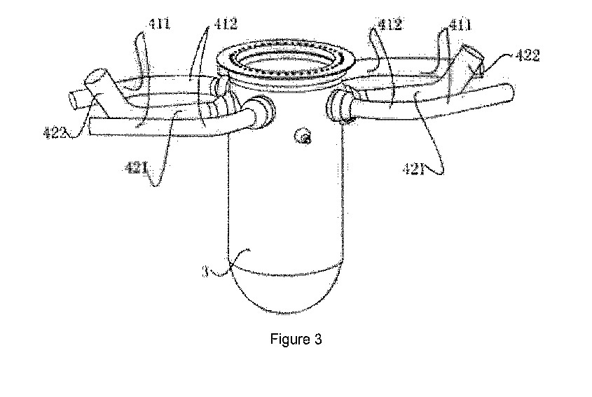

In the figures, FIG. 1 displays the reactor coolant system of pressurized water reactor nuclear power plants: the reactor pressure vessel 3 is in the middle; the steam generator 1 and coolant pump 2 connected with the former are at two sides and are connected by reactor coolant loop piping 4. The reactor coolant loop piping comprises cold legs 41 and hot legs 42. Two coolant pumps 2 are arranged on the nozzles at two sides of the lower head of the steam generator 1. The steam generator 1, coolant pumps 2 and the reactor pressure vessel 3 form a closed loop through the reactor coolant loop piping.

The end of reactor coolant loop piping 4 which is connected with the reactor pressure vessel 3 is called the reactor pressure vessel end for short, while the end of reactor coolant loop piping 4 which is connected with the steam generator 1 and coolant pump 2 is called the steam generator end. The reactor coolant loop piping hot leg 42 is connected with the reactor pressure vessel 3 by the joint 342 and with the steam generator 1 by the joint 142; the reactor coolant loop piping cold leg 41 is connected with the reactor pressure vessel 3 by the joint 341 and with coolant pump 2 by the joint 241. The reactor coolant loop piping cold leg 41 comprises straight sections 411 and bent sections 412 and the latter is adjacent the reactor pressure vessel 3 side. The reactor coolant loop piping hot leg 42 comprises straight sections 421 and bent sections 422 and the latter is close to the steam generator 1 side.

### Exemplary Embodiment

In January of 2009, construction of the first AP1000 pressurized water reactor in the world was started officially in Sanmen County, Zhejiang Province. Each unit comprises two loops composed of six installed joints, wherein, four joints are on two cold legs and two joints on one hot leg without transition section. The reactor coolant loop piping is made of 316LN extra-low-carbon stainless steel, wherein, the specification of the hot leg is 37.5″×3.25″ (diameter X wall thickness) and the specification of the cold leg is 27″×2.56″ (diameter X wall thickness). According to the three-level schedule provided by the design unit, a long time period shall be taken for the supply and delivery of the steam generator and the reactor pressure vessel and the installation milestones of the primary system equipments are critical during construction period, therefore the installation procedure adopted is to perform fit-up and welding to the hot and cold legs of reactor coolant loop piping and the reactor pressure vessel by making use of temporary support with laser tracking metrology and 3D modeling technology and field NC weld prep machining technology prior to the arrival of the steam generator; then the welding between reactor coolant loop piping and the steam generator and coolant pump shall be conducted after the arrival of the steam generator.

To shorten the installation time of pressurized water reactor nuclear power plants, the following three installation methods can be adopted according to the different installation order of the steam generator 1 and the reactor pressure vessel 3: 1) Start installation from the reactor pressure vessel 3 end to the steam generator 1 end; 2) Start installation from the steam generator 1 end to the reactor pressure vessel 3 end; 3) Start from the cold leg bent (412) and the hot leg bent (422) of reactor coolant loop piping 4, then followed by the installation of the cold leg straight (411) and the hot leg straight (421);

Describe the invention in detail in combination with the drawings thereinafter.

### Embodiment 1

The embodiment starts installation from a reactor pressure vessel 3 end to the steam generator 1 end firstly, which is suitable when the steam generator 1 is not received and the reactor pressure vessel 3 is received; the specific installation method is as bellow:

1) Check the prerequisites for installation.

2) Install the reactor pressure vessel 3 into position. If the steam generator 1 is not received, the steam generator and coolant pump shall not be installed temporarily.

3) Adopt laser tracking to measure the reactor pressure vessel 3 and obtain nozzle data, and make 3D modeling according to the data; if the steam generator 1 is not received, directly refer to the measurement data offered by the supplier or measure the steam generator 1 and coolant pump 2 at the place of the supplier by laser tracking and make 3D modeling.

4) Measure the cold leg and the hot leg of reactor coolant loop piping by laser tracking to obtain data, and make 3D modeling and data fitting based on the data.

5) Adopt NC-tracking weld prep machining technology, machine the weld prep of reactor coolant loop piping 4 at the reactor pressure vessel 3 end. Measure the weld prep features by laser tracking to obtain data.

6) Install temporary supports for reactor coolant loop piping 4.

7) Hoist and move the whole reactor coolant loop piping 4, and adjust the position to limit the displacement deviation of reactor coolant loop piping 4 and the reactor pressure vessel 3 within the allowable range for welding.

8) Complete the fit-up between cold legs and hot leg of reactor coolant loop piping at the reactor pressure vessel end and the nozzles of the reactor pressure vessel 3.

9) Complete the welding of joints 342 and 341 at the reactor pressure vessel end.

Clean and check the weld prep firstly to meet the welding requirements; adopt tack welding or internal expanding support for temporary fixing; monitor and adjust the end deformation of reactor coolant loop piping 4 at the steam generator end due to welding by measurement technology to ensure the nozzle orientation at the steam generator end can be processed and limited within allowed size range.

Perform formal welding: weld the joints 341 and 342 to achieve 15 mm, 50%, 100% thickness, and conduct non-destructive examination. When the welding is qualified after being checked and repaired, grind and polish the joint surface, provide joint mark and report.

10) Adopt NC-tracking weld prep machining technology to machine the weld prep of reactor coolant loop piping at the steam generator end.

11) When a steam generator 1 is received, check the prerequisites firstly; upon qualified, install the steam generator 1 and coolant pump 2 into position, then complete the fit-up between the steam generator1 nozzles and the cold legs and hot leg of reactor coolant loop piping 4 at the steam generator end.

12) Clean and check the weld preps of the hot leg 42 and the cold leg 41 of reactor coolant loop piping at the steam generator end to meet the welding requirements. Complete the welding of the joint 142 between reactor coolant loop piping hot leg 42 at the steam generator end and the nozzle of the steam generator 1; simultaneously, complete the welding of two joints 241 between reactor coolant loop piping cold legs 41 at the steam generator end and the nozzles of coolant pump 2, which is one of the most important technological difficulties for the invention. The accuracy is ensured by adopting laser tracking metrology technology, 3D modeling, data fitting technology and NC-tracking weld prep machining technology.

Perform the fit-up between reactor coolant loop piping cold leg 41 at the steam generator end and the nozzle of coolant pump 2, and between the hot leg 42 and the nozzle of the steam generator 1 firstly, then adopt tack welding for temporary fixing.

Perform formal welding: weld the joints 241 and 142 to achieve 15 mm, 50%, 100% thickness, and conduct non-destructive examination. When the welding is qualified after being checked and repaired, grind and polish the joint surface, provide joint mark and report.

13) Complete reactor coolant loop piping installation of reactor coolant system in nuclear power plants. Perform overall detection and the final conformance inspection after installation of reactor coolant loop piping by laser tracking metrology and non-destructive examination technology.

Furthermore, the mentioned joint 341 between reactor coolant loop piping cold leg 41 at the reactor pressure vessel end and the reactor pressure vessel 3, and the joint 342 between reactor coolant loop piping hot leg 42 and the reactor pressure vessel can be welded at the same time;

The mentioned joint 241 between reactor coolant loop piping cold leg 41 at the steam generator end and coolant pump 2, and the joint 142 between reactor coolant loop piping hot leg 42 and the steam generator 1 can be welded at the same time;

In addition, the above welding can be performed in two or more loops in parallel.

### Mode for Invention

### Embodiment 2

The embodiment starts installation from the a steam generator 1 end to the reactor pressure vessel 3 end firstly, which is suitable when the steam generator 1 and coolant pump 2 are delivered and the reactor pressure vessel 3 is undelivered; the specific installation method is as below:

1) Check the prerequisites for installation.

2) Install the steam generator 1 and coolant pump 2 into position. If the reactor pressure vessel 3 is undelivered, no installation shall be conducted temporarily.

3) Adopt laser tracking to measure the nozzles of the steam generator 1 and coolant pump 2; if the reactor pressure vessel 3 is undelivered, directly refer to the data offered by the supplier; or measure the nozzle data of the reactor pressure vessel 3 at the place of the supplier by laser tracking and make 3D modeling based on the data.

4) Measure the cold leg and the hot leg of reactor coolant loop piping by laser tracking to obtain data, and make 3D modeling and data fitting based on the data.

5) Adopt NC-tracking weld prep machining technology, machine the weld prep of reactor coolant loop piping 4 at the steam generator 1 end. Measure the weld prep features by laser tracking to obtain data.

6) Install temporary supports for reactor coolant loop piping 4.

7) Hoist and move the whole reactor coolant loop piping 4, and adjust the position to limit the displacement deviation of reactor coolant loop piping 4 and the steam generator 1 and coolant pump 2 nozzle within the allowable range for welding.

8) Complete the fit-up between the cold legs and hot leg of reactor coolant loop piping 4 at the steam generator end and the nozzles of the steam generator 1 and coolant pump 2.

Complete the welding of joints 142 and 241 at the steam generator end.

Clean and check the weld preps firstly to meet the welding requirements; adopt tack welding or internal expanding support for temporary fixing; monitor and adjust the end deformation of reactor coolant loop piping 4 at the steam generator end due to welding by measurement technology to ensure the nozzle orientation at the steam generator end can be processed and limited within allowed size range.

Perform formal welding: weld the joints 241 and 142 to achieve 15 mm, 50%, 100% thickness, and conduct non-destructive examination. When the welding is qualified after being checked and repaired, grind and polish the joint surface, provide joint mark and report.

10) Adopt NC-tracking weld prep machining technology to machine the weld prep of reactor coolant loop piping at the reactor pressure vessel end.

11) When the reactor pressure vessel 3 is delivered, check the prerequisites firstly; upon qualified, install the reactor pressure vessel 3 into position, then complete the fit-up between the reactor pressure vessel 3 nozzles and the cold legs and hot leg of reactor coolant loop piping 4 at the reactor pressure vessel end;

12) Clean and check the weld preps of the hot leg 42 and the cold leg 41 of reactor coolant loop piping at the reactor pressure vessel end to meet the welding requirements. Complete the welding of the joint 342 between reactor coolant loop piping hot leg 42 at the reactor pressure vessel end and the nozzle of the reactor pressure vessel 3; simultaneously, complete the welding of two joints 341 between reactor coolant loop piping cold leg 41 at the reactor pressure vessel end and the nozzle of coolant pump 2, which is one of the most important technological difficulties for the invention. The accuracy is ensured by adopting laser tracking metrology technology, 3D modeling, data fitting technology and NC-tracking weld prep machining technology.

Perform the joint fit-up between the cold leg 41 and the hot leg 42 of reactor coolant loop piping at the reactor pressure vessel end and the nozzles of the reactor pressure vessel 3, and then conduct temporary fixing.

Perform formal welding: weld the joints 341 and 342 to achieve 15 mm, 50%, 100% thickness, and conduct non-destructive examination. When the welding is qualified after being checked and repaired, grind and polish the joint surface, provide joint mark and report.

13) Complete reactor coolant loop piping installation of reactor coolant system in nuclear power plants. Perform overall detection and final conformance inspection after installation of reactor coolant loop piping by laser tracking metrology and non-destructive examination technology.

Furthermore, the mentioned joint 341 between reactor coolant loop piping cold leg 41 at the reactor pressure vessel end and the reactor pressure vessel 3, and the joint 342 between reactor coolant loop piping hot leg 42 and the reactor pressure vessel can be welded at the same time;

The mentioned joint 241 between reactor coolant loop piping cold leg 41 at the steam generator end and coolant pump 2, and the joint 142 between reactor coolant loop piping hot leg 42 and the steam generator 1 can be welded at the same time;

In addition, the above welding can be performed in two or more loops in parallel.

### Embodiment 3

The embodiment starts fit-up and welding for bent section of reactor coolant loop piping 4 firstly, followed by the straight section, which is suitable when the steam generator 1 and the reactor pressure vessel 3 are delivered. Or, measure the 3D data of the pipe nozzle and the weld prep at the safety end in the manufacturer, to shorten site construction period. The specific installation method is as bellow:

1) Check the prerequisites.

2) Adopt laser tracking to measure the steam generator 1, coolant pump 2 and the reactor pressure vessel 3 and obtain nozzle data, and make 3D modeling according to the data.

3) Adopt laser tracking to measure the cold and hot legs of reactor coolant loop piping 4 and obtain data, and make 3D modeling according to the data. Measure the weld prep features of reactor coolant loop piping to be processed by laser tracking to achieve data confirmation, and make 3D modeling and weld prep fitting.

4) Adopt NC-tracking weld prep machining technology, to machine the weld prep at the steam generator end and the reactor pressure vessel end of reactor coolant loop piping.

5) Install temporary supports for reactor coolant loop piping 4.

6) Hoist and move reactor coolant loop piping 4 onto temporary supports.

7) Install the steam generator 1, coolant pump 2 and the reactor pressure vessel 3 into position. Adjust the position of reactor coolant loop piping 4 and the steam generator 1, to ensure the installation deviation of the bent section 412 for the cold leg 41 of reactor coolant loop piping and the reactor pressure vessel 3 at the reactor pressure vessel end and the installation deviation of the bent section 422 for the hot leg 42 of reactor coolant loop piping and the nozzle of the steam generator 1 at the steam generator end are within the allowable range for welding.

8) Complete the fit-up between reactor coolant loop piping cold leg 412 bent at the reactor pressure vessel end and the nozzle of the reactor pressure vessel 3; complete the assembly of reactor coolant loop piping hot leg 422 bent at the steam generator end and the nozzle of the steam generator 1.

9) Complete the welding of joints 341 and 142. Clean and check the weld preps of reactor coolant loop piping cold leg 412 bent at the reactor pressure vessel end and the hot leg 422 bent at the steam generator end firstly to meet the welding requirements; adopt tack welding for temporary fixing; monitor and adjust the deformation of reactor coolant loop piping at the other end due to welding and change the welding procedure timely to ensure the end of reactor coolant loop piping without fit-up and welding is within the allowed size range in the nozzle orientation of the equipment requiring fit-up and welding.

Perform formal welding: weld the joints 341 and 142 to achieve 15 mm, 50%, 100% thickness, and conduct non-destructive examination. When the welding is qualified after being checked and repaired, grind and polish the joint surface, provide joint mark and report.

10) Obtain the data of cold leg 411 straight and hot leg 421 straight of reactor coolant loop piping by tracking measurement, control the welding deformation trend and adjust the welding order and the position of the steam generator to ensure the cold leg 411 straight and the hot leg 421 straight of reactor coolant loop piping meet fit-up requirements. Fit up coolant pump 2 with reactor coolant loop piping cold leg 411 straight at the steam generator end; and fit up the reactor pressure vessel 3 with reactor coolant loop piping hot leg 421 straight at the reactor pressure vessel end.

11) Clean and check the weld prep of the cold leg 411 straight and the hot leg 421 straight of reactor coolant loop piping to meet the welding requirements. Complete the fit-up and welding of the joint 241 between reactor coolant loop piping cold leg 411 straight at the steam generator end and coolant pump 2; simultaneously, complete the fit-up and welding of the joint 342 between reactor coolant loop piping hot leg 421 straight at the reactor pressure vessel end and the reactor pressure vessel 3.

Perform the joint fit-up between reactor coolant loop piping cold leg 411 straight at the steam generator end and coolant pump 2, and between the hot leg 421 straight and the reactor pressure vessel 3 at the reactor pressure vessel end firstly, then adopt tack welding for temporary fixing.

Perform formal welding: weld the joints 241 and 342 to achieve 15 mm, 50%, 100% thickness, and conduct non-destructive examination. When the welding is qualified after being checked and repaired, grind and polish the joint surface, provide joint mark and report.

12) Complete reactor coolant loop piping installation of reactor coolant system in pressurized water reactor nuclear power plants. Perform overall detection and final conformance inspection after installation of reactor coolant loop piping by measurement and non-destructive examination technology.

Furthermore, the mentioned joint 341 between reactor coolant loop piping cold leg 412 bent at the reactor pressure vessel end and the reactor pressure vessel 3, and the joint 142 between reactor coolant loop piping hot leg 422 bent at the steam generator end and the steam generator 1 can be welded at the same time;

The mentioned joint 241 between reactor coolant loop piping cold leg 411 straight at the steam generator end and coolant pump, and the joint 342 between reactor coolant loop piping hot leg 421 straight at the reactor pressure vessel end and the reactor pressure vessel 3 can be welded at the same time;

In addition, the above fit-up and welding can be performed in two or more loops in parallel.

### Embodiment 4

The embodiment starts fit-up and welding for the straight section of reactor coolant loop piping 4 firstly, followed by the bent section, which is suitable when the steam generator 1 and the reactor pressure vessel 3 are delivered. Or, measure the 3D data of the nozzles and weld preps of the safety end in the manufacturer, to shorten site construction period. The specific installation method is as bellow:

1) Check the prerequisites.

2) Adopt laser tracking to measure the steam generator 1, coolant pump 2 and the reactor pressure vessel 3 and obtain nozzle data, and make 3D modeling according to the data.

3) Adopt laser tracking to measure the cold and hot legs of reactor coolant loop piping 4 and obtain data, and make 3D modeling according to the data. Measure the weld prep features of reactor coolant loop piping to be processed by laser tracking to achieve data confirmation, and make 3D modeling and data fitting for weld preps' fit-up.

4) Adopt NC-tracking weld prep machining technology, to machine the weld preps at the steam generator end and the reactor pressure vessel end of reactor coolant loop piping.

5) Install temporary supports for reactor coolant loop piping 4.

6) Hoist and move reactor coolant loop piping 4.

7) Install the steam generator 1, coolant pump 2 and the reactor pressure vessel 3 into position. Adjust the position of reactor coolant loop piping 4 and the steam generator 1, to ensure the installation deviation of the straight section 411 for the cold leg 41 of reactor coolant loop piping and coolant pump 2 at the reactor pressure vessel end and the installation deviation of the straight section 421 for the hot leg 42 of reactor coolant loop piping and the nozzle of the reactor pressure vessel 3 at the steam generator end are within the allowable range for welding.

8) Complete the fit-up between reactor coolant loop piping hot leg 421 straight at the reactor pressure vessel end and the nozzle of the reactor pressure vessel 3; complete the fit-up between reactor coolant loop piping cold leg 411 straight at the steam generator end and the nozzle of coolant pump 2.

9) Complete the welding of joints 342 and 241. Clean and check the weld preps of reactor coolant loop piping hot leg 421 straight at the reactor pressure vessel end and the cold leg 411 straight at the steam generator end firstly to meet the welding requirements; adopt tack welding for temporary fixing; monitor and adjust the deformation of reactor coolant loop piping at the other end due to welding and change the welding procedure timely to ensure the end of reactor coolant loop piping without fit-up and welding is within the allowed size range in the nozzle orientation of the equipment requiring fit-up and welding.

Perform formal welding: weld the joints 241 and 342 to achieve 15 mm, 50%, 100% thickness, and conduct non-destructive examination. When the welding is qualified after being checked and repaired, grind and polish the joint surface, provide joint mark and report.

10) Obtain the data of cold leg 412 bent and hot leg 422 bent of reactor coolant loop piping by tracking measurement, control the welding deformation trend and adjust the welding order and the position of the steam generator to ensure the cold leg 412 bent and the hot leg 422 bent of reactor coolant loop piping meet fit-up requirements. Fit up the steam generator 1 with reactor coolant loop piping hot leg 422 bent at the steam generator end; and fit up the reactor pressure vessel 3 with reactor coolant loop piping cold leg 412 bent at the reactor pressure vessel end.

11) Clean and check the weld preps of the cold leg 412 bent and the hot leg 422 bent of reactor coolant loop piping to meet the welding requirements. Complete the fit-up and welding of the joint 142 between reactor coolant loop piping hot leg 422 bent at the steam generator end and the steam generator 1; simultaneously, complete the fit-up and welding of the joint 341 between reactor coolant loop piping cold leg 412 bent at the reactor pressure vessel end and the reactor pressure vessel 3.

Perform the joint fit-up between reactor coolant loop piping hot leg 422 bent at the steam generator end and the steam generator 1, and between the cold leg 412 bent and the reactor pressure vessel 3 at the reactor pressure vessel end firstly, then adopt tack welding for temporary fixing.

Perform formal welding: weld the joints 341 and 142 to achieve 15 mm, 50%, 100% thickness, and conduct non-destructive examination. When the welding is qualified after being checked and repaired, grind and polish the joint surface, provide joint mark and report.

12) Complete reactor coolant loop piping installation of reactor coolant system in pressurized water reactor nuclear power plants. Perform overall detection and final conformance inspection after installation of reactor coolant loop piping by measurement and non-destructive examination technology.

Furthermore, the mentioned joint 342 between reactor coolant loop piping hot leg 421 straight at the reactor pressure vessel end and the reactor pressure vessel 3, and the joint 241 between reactor coolant loop piping cold leg 411 straight at the steam generator end and coolant pump 2 can be welded at the same time;

The mentioned joint 341 between reactor coolant loop piping cold leg 412 bent at the reactor pressure vessel end and the reactor pressure vessel 3, and the joint 142 between reactor coolant loop piping hot leg 422 bent at the steam generator end and the steam generator 1 can be welded at the same time;

In addition, the above fit-up and welding can be performed in two or more loops in parallel.

### Embodiment 5

The embodiment is applicable when the steam generator 1, coolant pump 2 and the reactor pressure vessel 3 are all delivered, and reactor coolant loop piping cold and hot legs can be welded simultaneously at the ends of the reactor pressure vessel and the steam generator.

Conduct measurement and modeling for nozzles of the steam generator (1), coolant pump (2), the reactor pressure vessel (3) and reactor coolant loop piping (4) by using laser measurement or precise measurement technologies and 3D modeling technology; survey the cold legs (41) and the hot legs (42) of reactor coolant loop piping (4) to perform the weld prep machining; adjust the position of the steam generator (1) and reactor coolant loop piping (4), to conduct fit-up and welding for six joints simultaneously or successively, thus finishing the installation.

### INDUSTRIAL APPLICABILITY

The invention takes the two-loop reactor coolant system for AP1000 advanced pressurized water reactor nuclear power plants as an example, but is not limited to AP1000 pressurized water reactor nuclear power plants and two loops.

1-10. (canceled)

11. A method of installing reactor coolant loop piping of a coolant system in a pressurized water reactor nuclear power plant, which comprises:
positioning the reactor vessel, steam generator, or both, into position after attaching one or more coolant pumps;
surveying coolant loop piping and a plurality of nozzles on the reactor vessel, the steam generator and coolant pump casing, or a combination thereof, with a precise measurement and 3D modeling technology for positioning data;
then performing weld prep machining for the coolant loop piping on the reactor vessel side, and machining for the coolant loop piping on the steam generator side and coolant pump side based on the positioning data; and
installing temporary supports for coolant loop piping and finishing the fit-up and welding between the coolant loop piping and the reactor vessel, steam generator, and each coolant pump,
wherein the one or more coolant pumps are directly attached to the steam generator, and the coolant loop piping has at least one cold leg and at least one hot leg.

12. The method of claim 11, wherein the precise measurement technology is selected to comprise laser measurement technology.

13. The method of claim 11, wherein the installing comprises welding of joints between coolant loop piping and the reactor vessel; the surveying comprises conducting 3D modeling on the coolant loop piping and the plurality of nozzles on the steam generator and coolant pumps by laser measurement and 3D modeling technology; and further comprising determining the dimensions of end faces of coolant loop piping on the steam generator side before performing the weld prep machining, wherein the steam generator has first been positioned, then finishing the fit-up and welding of joints between each coolant loop piping hot leg and the steam generator and between each coolant loop piping cold leg and each coolant pump to complete the installation of coolant loop piping.

14. The method of claim 11, wherein the installing comprises welding of joints between the coolant loop piping and the steam generator and each coolant pump, wherein the surveying for the coolant loop piping and the nozzles on the reactor vessel comprises laser measurement and 3D modeling so as to determine the dimensions of coolant loop piping on the reactor vessel side before the weld prep machining, and wherein the reactor vessel has first been positioned and then finishing the fit-up and welding of joints between the coolant loop piping and the reactor vessel so as to complete the installation of coolant loop piping.

15. The method of claim 11, wherein if the reactor vessel and steam generator are positioned in place, a plurality of coolant loop piping bent sections shall be fit-up and welded first followed by a plurality of straight sections.

16. The method of claim 15, wherein the fit-up and welding comprises welding of a joint between a bent coolant loop piping cold leg and the reactor vessel, then welding of a joint between a bent coolant loop piping hot leg and the steam generator; wherein the surveying for joints of coolant loop piping, reactor vessel, and each coolant pump uses laser measurement and 3D modeling technology; wherein the machining and fit-up comprises installing coolant loop piping hot leg from a joint at a steam generator end to a reactor vessel end, then machining and fit-up by installing coolant loop piping cold leg from a joint at a reactor vessel end to a coolant pump end; and further comprising welding of a joint between a straight coolant loop piping hot leg and the reactor vessel and a joint between a straight coolant loop piping cold leg and each coolant pump so as to complete the installation of coolant loop piping.

17. The method of claim 11, wherein if the reactor vessel and steam generator are in place, a coolant loop piping straight section is assembled and welded first followed by a bent section, which comprises:
welding of a joint between a coolant loop piping straight cold leg and a coolant pump, and welding of a joint between a coolant loop piping straight hot leg and the reactor vessel;
surveying of joints of coolant loop piping, reactor vessel, and each coolant pump by using laser measurement and 3D modeling, machining and fit-up by installing coolant loop piping hot leg from a joint at the reactor vessel end to a steam generator end, and machining and fit-up by installing coolant loop piping cold leg from a joint at a coolant pump end to a reactor vessel end; and
welding of a joint between a bent coolant loop piping hot leg and the steam generator and a joint between a bent coolant loop piping cold leg and the reactor vessel so as to complete installation of coolant loop piping.

18. The method of claim 11, wherein if the reactor vessel and steam generator are in place, the cold and hot legs of coolant loop piping are welded at the same time.

19. The method of claim 18, wherein the surveying comprises measuring and modeling a plurality of nozzles of the steam generator, coolant pump, reactor vessel, and coolant loop piping with laser measurement and 3D modeling so as to determine the size of the cold leg and the hot leg to be machined off, and then performing the weld prep machining; and adjusting the positions of the steam generator, coolant loop piping, or both, to weld six joints simultaneously or successively.

20. The method of claim 19, wherein the welding of six joints completes installation of the coolant loop piping.

21. The method of claim 11, wherein the surveying of the coolant loop piping comprises laser measurement and 3D modeling of the coolant loop piping and the plurality of nozzles, and wherein the machining and installing are conducted according to the modeling calculation results.

22. The method of claim 11, wherein the machining comprises numerical control machining the coolant loop piping.

23. The method of claim 11, wherein the welding comprises narrow groove tungsten inert gas automatic welding the coolant loop piping.
